(19) United States
(12) Patent Application Publication
(10) Pub. No.: US 2011/0307471 A1
(43) Pub. Date: Dec. 15, 2011

(54) Accelerating Database Management System Operations

(75) Inventor: Vadim Sheinin, Mount Kisco, NY (US)

(73) Assignee: INTERNATIONAL BUSINESS MACHINES CORPORATION, Armonk, NY (US)

(21) Appl. No.: 12/796,759

(22) Filed: Jun. 9, 2010

(51) Int. Cl. G06F 17/30

(52) U.S. Cl. 707/714; 707/752; 707/E17.054; 707/E17.104

(57) ABSTRACT

Techniques for accelerating an operation in a database management system are provided. The techniques include reading data pertaining to a database management system operation from a storage unit, sending the database management system operation data to an accelerator unit, and processing the database management system operation data via the accelerator unit, wherein processing the data via the accelerator unit comprises using a multithreaded execution unit and compression hardware to perform the database management system operation with reduced execution time.

### FIELD OF THE INVENTION

Embodiments of the invention generally relate to information technology, and, more particularly, to database management systems (DBMS).

### BACKGROUND OF THE INVENTION

Database management systems (DBMS) operations, such as, for example, a sort operation, are used extensively. Sort, for instance, can be used for index creation, order by, merge join, pushed-down aggregation, etc. However, dealing with large tables, which is very common, for data warehousing requires a lot of time to process sort.

A challenge with sort, for example, is that if the input data size is smaller than the system memory, then sort performance is very quick because everything fits in the central processing unit (CPU) memory. Such sort is referred to as an internal sort. But when the data size is bigger than the available memory or bigger than the memory allotted internally by DBMS for sorts, then external sort is performed which includes reading from disk a chunk of data that can fit into available memory, sorting it and writing it back to disk. This is referred to as a sorted run. Such a process would continue reading another run, sorting it and so on until the entire input file was read and sorted runs were created. A second phase, referred to as a merge phase, can then commence, wherein information is read from the disk and merged to create a final sorted file.

By way of illustration, external sort will write N bytes to the disk, read N bytes from the disk, and perform sort/merge operations, with N being an input file size. These 2N input/output (I/O) operations limit sort performance. Even if disks are very fast, physical storage interfaces will limit the I/O performance. CPU contribution to the sort/merge can be reduced by parallel programming, but storage throughput will be limited by the interface. Further, when the disk subsystem is not very fast, it becomes a bottleneck of the sort operation.

Consequently, a challenge exists in sorting data sets that are too large to fit into a main memory (assuming that data are stored on a disk drive). There is a need, therefore, to accelerate external sort in DBMS.

### SUMMARY OF THE INVENTION

Principles and embodiments of the invention provide techniques for accelerating database management system operations. An exemplary method (which may be computer-implemented) for accelerating an operation in a database management system, according to one aspect of the invention, can include steps of reading data pertaining to a database management system operation from a storage unit, sending the database management system operation data to an accelerator unit, and processing the database management system operation data via the accelerator unit, wherein processing the data via the accelerator unit comprises using a multithreaded execution unit and compression hardware to perform the database management system operation with reduced execution time.

One or more embodiments of the invention or elements thereof can be implemented in the form of a computer product including a tangible computer readable storage medium with computer useable program code for performing the method steps indicated. Furthermore, one or more embodiments of the invention or elements thereof can be implemented in the form of an apparatus including a memory and at least one processor that is coupled to the memory and operative to perform exemplary method steps. Yet further, in another aspect, one or more embodiments of the invention or elements thereof can be implemented in the form of means for carrying out one or more of the method steps described herein; the means can include (i) hardware module(s), (ii) software module(s), or (iii) a combination of hardware and software modules; any of (i)-(iii) implement the specific techniques set forth herein, and the software modules are stored in a tangible computer-readable storage medium (or multiple such media).

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 is a diagram illustrating a traditional DBMS system running on a CPU, according to an embodiment of the invention;

FIG. 2 is a diagram illustrating a DBMS system with an accelerator component, according to an embodiment of the invention;

FIG. 3 is a diagram illustrating internal structure of a DBMS accelerator, according to an embodiment of the invention;

FIG. 4 is a diagram illustrating an example of accelerating CPU contribution of sort, according to an embodiment of the present invention;

FIG. 5 is a flow diagram illustrating techniques for accelerating an operation in a database management system, according to an embodiment of the invention; and

FIG. 6 is a system diagram of an exemplary computer system on which at least one embodiment of the invention can be implemented.

### DETAILED DESCRIPTION OF EMBODIMENTS

Principles of the invention include accelerating operations (such as, for example, join, sort, etc.) in database management systems (DBMS). One or more embodiments of the invention include combining data compression within a sort engine to improve I/O performance. By way of example, one or more embodiments of the invention can include an external sorting algorithm that makes the initial runs as long as possible, overlaps input, processing and output as much as possible at all stages, uses as much working memory as possible, uses additional disk drives (if possible) for more overlapping of processing with I/O, and allows for more sequential file processing.

As noted, software based data compression may not be able to cope with high rates of sort. What is needed is hardware data compression integrated on the same central processing unit (CPU) responsible for sort, join, etc. to sustain increased data compression without being a burden on the processor. As detailed herein, one or more embodiments of the invention include using data compression combined with sort, join and other operations to reduce the amount of temporal information written and read from the disks, and consequently reducing the time needed to write/read this information to/from disks.

Aspects of the techniques described herein can include, for example, external sort whereby sorted runs are compressed before being stored to an external disk and read as compressed, then decompressed, and then merged. During the compression process, the entire record can be compressed, or merely a non-key part of the record can be compressed. Moreover, compression can be performed, for example, after sort of a particular run and, as such, compression can be applied to a sorted sequence of data which will improve compression performance, further reduce the size of the data stored on the disk, and consequently reduce the time needed to store the data. Additionally, one or more embodiments of the invention include applying the same logic to a hash join operator and any other operator processing large data files in chunks that are temporarily written or read to/from disks.

FIG. 1 is a diagram illustrating a traditional DBMS system running on a CPU, according to an embodiment of the invention. By way of illustration, FIG. 1 depicts a storage subsystem 100, CPU 103 and memory component (for example, dynamic random access memory (DRAM)) 104. When a sort is performed, a table is read from the storage subsystem 100 and loaded, via interface 101 (as depicted in FIG. 1) into external memory 104, and there it is sorted by way of CPU 103. In the case of a join of two tables, these two tables will be read from the storage subsystem 100, loaded into memory 104 and joined there by way of CPU 103.

Sort and join can be relatively fast. Performance problems can start when the size of a table (or tables in the case of join) are bigger than memory 104. In such a case, for example, during a sort process, an initial table to be sorted is loaded into memory 104 chunk-by-chunk, and each chunk is sorted separately and written to storage subsystem 100. After all chunks have been sorted (each one by itself), they are read into memory 104 (for example, a portion from each chunk) and merged. This process can include writing and reading intermediate results (sorted runs) to/from storage subsystem 100.

One or more embodiments of the invention can also include performing a hash join. For purposes of illustration, assume that one table fits in the memory 104, but a second bigger table does not fit. As such, the smaller table will be read into the memory 104 and a hash table will be built. The bigger table will be read, chunk-by-chunk, into memory 104, with each chunk hashed and written back to storage subsystem 100. After all of the chunks have been hashed and written to storage subsystem 100, the chunks are read one-by-one and joined with the smaller hashed table. The process of join (as well as others) is similar to the process of sort in that intermediate results are written and read to/from storage subsystem 100, which can be a slow process.

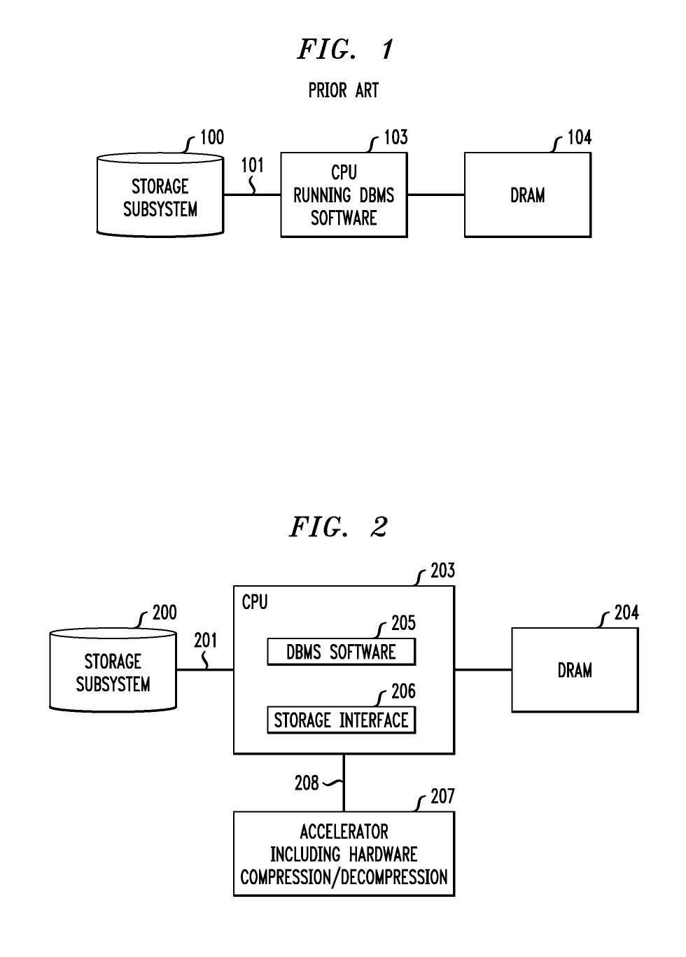

FIG. 2 is a diagram illustrating a DBMS system with an accelerator component, according to an embodiment of the invention. By way of illustration, FIG. 2 depicts a storage subsystem 200, a storage interface 201, CPU 203 (which includes a DBMS software component 205 and a storage interface component 206), memory component (for example, dynamic random access memory (DRAM)) 204, and an accelerator component (which includes hardware compression/decompression) 207.

As described herein, one or more embodiments of the invention include accelerating execution of sort, join and other operations, taking into consideration slow storage subsystem access times. As depicted in FIG. 2, the accelerator 207 is attached to CPU 203 through interface 208. In one or more embodiments of the invention, this interface can be through memory or any relatively fast interconnect/bus, so as not to be a bottleneck in the processing. By way of example and not limitation, one or more embodiments can include using a PCI-Express bus while putting an accelerator chip on a PCI-Express card inserted or connected to a traditional server running DBMS.

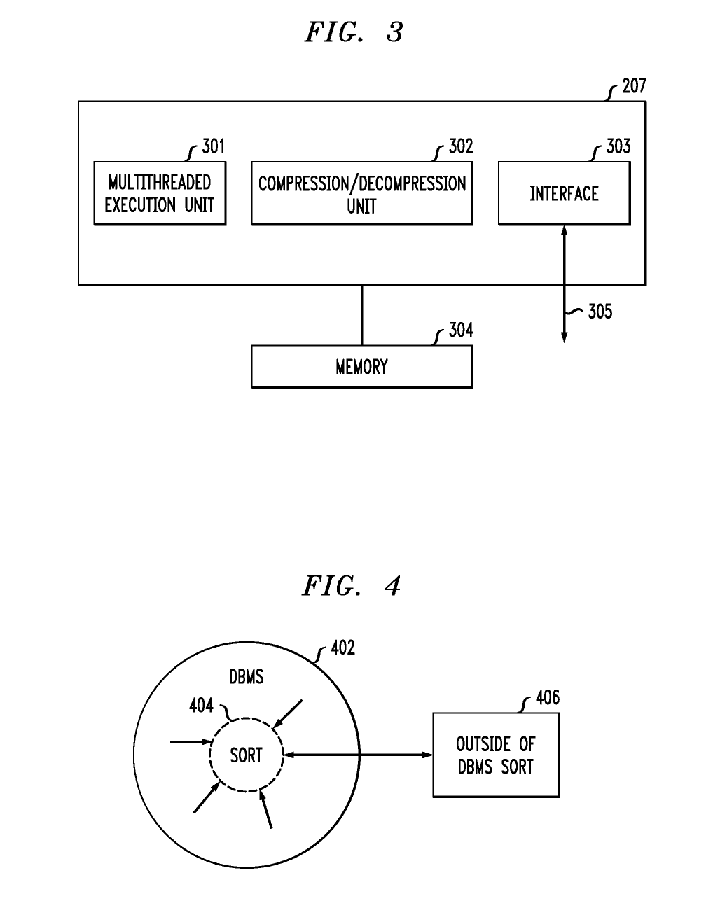

FIG. 3 is a diagram illustrating internal structure of a DBMS accelerator, according to an embodiment of the invention. By way of illustration, FIG. 3 depicts an accelerator component 207, which includes a multithreaded execution unit 301, a compression/decompression unit 302, and an interface component 303. FIG. 3 also depicts a memory component 304, and interface 305, which is an interface between the accelerator 207 and the DBMS system (it is depicted as interface 208 in FIG. 2).

Operations such as sort and join can be off-loaded to accelerator 207. By way of example, the data-flow of a sort can proceed as follows. A chunk from a table is read form the storage subsystem 200 and through additional software 206 running on CPU 203, and is sent to accelerator 207 through interface/bus 208. This chunk is sorted via a multithreaded execution unit 301, as depicted in FIG. 3, and sent to compression hardware 302, which is a part of accelerator 207. After being compressed, the information is sent back to storage subsystem 200 through software 206. While sorting each chunk, accelerator 207 uses memory 304. In one or more embodiments of the invention, this process continues until the last chunk of a table is sorted and stored on storage subsystem 200. Subsequently, a merge process starts which includes reading chunks form storage subsystem 200, sending them to accelerator 207, decompressing them on a decompression hardware 302 (which is a part of accelerator 207) and performing a merge on 301 using memory 304.

In one or more embodiments of the invention, a hash join process can use a similar path. For illustration purposes, assume that a smaller table to be joined does not fit inside accelerator memory 304. The smaller table can be read from storage subsystem 200 and sent to accelerator 207 through interface software 206. On a multithreaded execution unit 301, partitions for this smaller table can be created, compressed on 302 and sent to a storage component (for example, storage component 200, as depicted in FIG. 2). Additionally, a bigger table can be read from the storage subsystem 200 chunk-by-chunk, sent to accelerator 207, where it is hashed (creating partitions) and compressed using compressor 302, then sent to storage subsystem 200. This process can continue for the entire bigger table. When all of the chunks have been hashed, compressed and stored on storage subsystem 200, matching partitions of both tables can be read from storage subsystem 200, sent to accelerator 207, decompressed on unit 302, and a join can be performed and kept in memory 204. This process is highly parallel and execution unit 301 can perform several joins processing several chunks.

In one or more embodiments of the invention, an accelerator structure (such as depicted in FIG. 3) enables a well balanced system to perform external sort and join operations. This balance is achieved, for example, through the use of a multithreaded execution unit (for example, execution unit 301 in FIG. 3) that performs parallel operations quickly and reduces execution time. The balance can also be achieved via use of a compression/decompression unit (for example, compression/decompression unit 302 in FIG. 3) that enables writing/reading information to/from a storage subsystem in less time (because there is less information to write/read as a consequence of information being compressed), and thus, reducing I/O time. Further, one or more embodiments of the invention establish is a balance between execution and I/O operations.

Additionally, in one or more embodiments of the invention, compression/decompression hardware performs quickly enough not to be a bottleneck of the entire operation. For purposes of illustration, assume, for example, the use of a serial ATA (SATA) (Serial Advanced Technology Attachment)-II interface for storage subsystem, which is 6 gigabits per second (Gbit/sec), compression shall be performed at a speed of about 3 Gbit/sec. Also, a sort/join running on a multithreaded execution unit (such as component 301 in FIG. 3) shall run at the same speed as well. In this instance, an accelerator (such as component 207 in FIG. 2 and FIG. 3) will be running at a storage subsystem speed and the system will be I/O bound.

In one or more embodiments of the invention, an accelerator (such as component 207 in FIG. 2 and FIG. 3) can support multiple sort/join operations executed concurrently because a DBMS can have multiple users and/or queries with multiple sort/join operators.

Also, in one or more embodiments of the invention, data compression/decompression operations can run on the same multithreaded execution unit (for example, one that has enough computational power to run sort/join and compression/decompression) to allow for a new compression algorithm that is not supported by compression/decompression unit 302. This can work efficiently in the case when multithreaded execution unit 301 is strong enough computationally.

Additionally, in one or more embodiments of the invention, offloading sort/join/etc. DBMS operations from CPU 103 to accelerator 207 reduces elapsed time and also reduces CPU and memory pressure on CPU 103 and DBMS software running thereon, which helps with other users and/or queries running on CPU 103 natively.

FIG. 4 is a diagram illustrating an example of accelerating CPU contribution of sort, according to an embodiment of the present invention. By way of illustration, FIG. 4 depicts DBMS 402, which includes a sort operation component 404. FIG. 4 also depicts a component 406 for elements outside of the DBMS sort.

As illustrated in FIG. 4, one or more embodiments of the invention can include identifying an opportunity for acceleration of sort in a DBMS (for example, 2×-3×). By way of example and not limitation, performance of one blade connected to multiple disks (for example, ten disks) can be measured. Also, DBMS sort related functions can be rewritten to interface, for example, an external Peripheral Component Interconnect Express (PCIe) attached sort engine. Further, one or more embodiments of the invention can implement and/or modify graphics processing unit (GPU) code to work with DBMS sort routines to exercise a connection from the DBMS to an external sort engine.

As detailed herein, one or more embodiments of the invention include combining data compression with a sort operation. By way of example and not limitation, data compression ratios can typically be around two to three, while data compression is CPU intensive, and atypical modern multicore is capable of 1 Gbit/sec. As such, one or more embodiments of the invention include compressing sorted runs before they are written to a hard disk, thereby writing/reading less data in less time.

In one or more embodiments of the invention, for example, an algorithm for external sort will read a chunk of data from a disk, sort the chunk of data in main memory, compress and store it back to disk, and repeat this process until all data is read. Additionally, all of the sorted runs can be merged, a phase that will include decompression. In a case where key length is close to record length, for example, sorting and then compressing will improve compression efficiency. Further, while compressing, one or more embodiments of the invention can include compressing the entire record or just a non-key part thereof.

As also described herein, one or more embodiments of the invention include combining data compression with a hash join operator. A hash join operator can be used in a DBMS, by way of example, for data warehousing purposes. A hash join can have two phases: probe and build. During the probe phase, a hash version of the small table is created, and if it fits inside available main memory, there is no I/O except reading the large table record by record, computing hash and performing a comparison with the probe table. If probe table is larger than available memory, both tables are divided into buckets and buckets are written to disk and processed bucket by bucket (they shall fit into available memory). The read/write pattern is similar to that of sort, and data compression will speed a hash join operator (as well as other operations) in the same fashion.

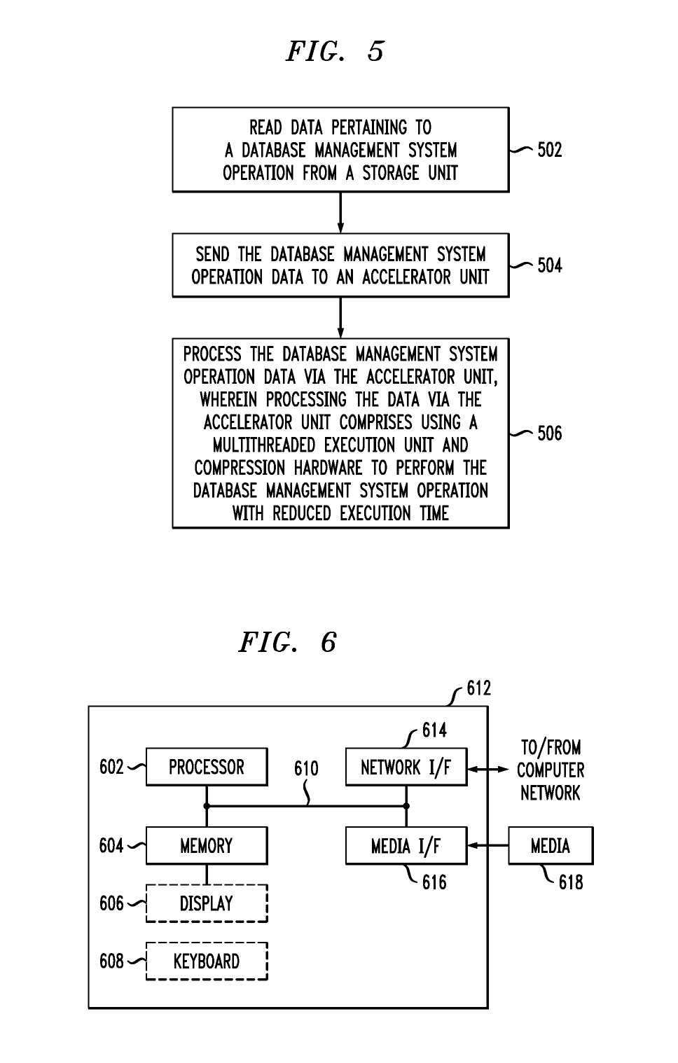

FIG. 5 is a flow diagram illustrating techniques for accelerating an operation in a database management system, according to an embodiment of the present invention. Step 502 includes reading data pertaining to a database management system operation from a storage unit. Step 504 includes sending the database management system operation data to an accelerator unit. Step 506 includes processing the database management system operation data via the accelerator unit, wherein processing the data via the accelerator unit comprises using a multithreaded execution unit and compression hardware to perform the database management system operation with reduced execution time.

As described herein, in one or more embodiments of the invention, the database management system operation can include a sort operation. In such a sort operation, by way of example, an item of data, from a table, is read from the storage unit and sent (for example, through additional software running on the CPU) to the accelerator unit through an interface. The data can sorted via the multithreaded execution unit, sent to compression hardware for compression, and sent back to the storage unit. Additionally, the steps of sorting and compressing the data can be repeated for the entirety of data from the table.

Also, one or more embodiments of the invention can include performing a merge process. The merge process can include reading items of data from the storage unit, sending the data to the accelerator unit, decompressing one or more items of the data on decompression hardware, and performing a merge of the items of data on the multithreaded execution unit.

Further, as described herein, in one or more embodiments of the invention, the database management system operation can include a join operation. In such a join operation, a first table (which includes one or more portions) is read from the storage unit (for example, read portion-by-portion). Each portion of the first table is sent to the accelerator unit through an interface, wherein each portion is hashed via the multithreaded execution unit and compressed using compressor hardware. Each hashed and compressed portion of the table can then be sent back to the storage unit. Additionally, a second table (for example, a second table (that includes one or more portions) that is larger in size than the first table) can be read from the storage unit (for example, read portion-by-portion), wherein each portion of the second table is sent to the accelerator unit. Each portion is then hashed and compressed using compressor hardware, and each compressed portion of the second table is sent back to the storage unit.

Further, one or more embodiments of the invention can include reading each hashed, compressed and stored portion of the first and second tables from the storage unit, sending each of those portions of the first and second tables to the accelerator unit, wherein each such portion is decompressed. In one or more embodiments of the invention, a join is then performed on the decompressed portions of the first and second tables. Further, in one or more embodiments of the invention, the joined portions of the first and second tables can be kept and/or maintained in memory with the hashed first table.

The techniques depicted in FIG. 5 can also, as described herein, include providing a system, wherein the system includes distinct software modules, each of the distinct software modules being embodied on a tangible computer-readable recordable storage medium. The distinct software modules can include, for example, a storage module, an accelerator module, a multithreaded execution module, a compression module, a decompression module, an interface module and a memory module executing on a hardware processor.

Additionally, the techniques depicted in FIG. 5 can be implemented via a computer program product that can include computer useable program code that is stored in a computer readable storage medium in a data processing system, and wherein the computer useable program code was downloaded over a network from a remote data processing system. Also, in one or more embodiments of the invention, the computer program product can include computer useable program code that is stored in a computer readable storage medium in a server data processing system, and wherein the computer useable program code are downloaded over a network to a remote data processing system for use in a computer readable storage medium with the remote system.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

One or more embodiments of the invention, or elements thereof can be implemented in the form of an apparatus including a memory and at least one processor that is coupled to the memory and operative to perform exemplary method steps.

One or more embodiments can make use of software running on a general purpose computer or workstation. With reference to FIG. 6, such an implementation might employ, for example, a processor 602, a memory 604, and an input/output interface formed, for example, by a display 606 and a keyboard 608. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input/output interface” as used herein, is intended to include, for example, one or more mechanisms for inputting data to the processing unit (for example, mouse), and one or more mechanisms for providing results associated with the processing unit (for example, printer). The processor 602, memory 604, and input/output interface such as display 606 and keyboard 608 can be interconnected, for example, via bus 610 as part of a data processing unit 612. Suitable interconnections, for example via bus 610, can also be provided to a network interface 614, such as a network card, which can be provided to interface with a computer network, and to a media interface 616, such as a diskette or CD-ROM drive, which can be provided to interface with media 618.

Accordingly, computer software including instructions or code for performing the methodologies of the invention, as described herein, may be stored in one or more of the associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

A data processing system suitable for storing and/or executing program code will include at least one processor 602 coupled directly or indirectly to memory elements 604 through a system bus 610. The memory elements can include local memory employed during actual implementation of the program code, bulk storage, and cache memories which provide temporary storage of at least some program code in order to reduce the number of times code must be retrieved from bulk storage during implementation.

Input/output or I/O devices (including but not limited to keyboards 608, displays 606, pointing devices, and the like) can be coupled to the system either directly (such as via bus 610) or through intervening I/O controllers (omitted for clarity).

Network adapters such as network interface 614 may also be coupled to the system to enable the data processing system to become coupled to other data processing systems or remote printers or storage devices through intervening private or public networks. Modems, cable modem and Ethernet cards are just a few of the currently available types of network adapters.

As used herein, including the claims, a “server” includes a physical data processing system (for example, system 612 as shown in FIG. 6) running a server program. It will be understood that such a physical server may or may not include a display and keyboard.

As noted, aspects of the present invention may take the form of a computer program product embodied in one or more computer readable medium(s) having computer readable program code embodied thereon. Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. Media block 618 is a non-limiting example. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, radio frequency (RF), etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, component, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It should be noted that any of the methods described herein can include an additional step of providing a system comprising distinct software modules embodied on a computer readable storage medium; the modules can include, for example, any or all of the components shown in FIG. 2 and FIG. 3. The method steps can then be carried out using the distinct software modules and/or sub-modules of the system, as described above, executing on one or more hardware processors 602. Further, a computer program product can include a computer-readable storage medium with code adapted to be implemented to carry out one or more method steps described herein, including the provision of the system with the distinct software modules.

In any case, it should be understood that the components illustrated herein may be implemented in various forms of hardware, software, or combinations thereof; for example, application specific integrated circuit(s) (ASICS), functional circuitry, one or more appropriately programmed general purpose digital computers with associated memory, and the like. Given the teachings of the invention provided herein, one of ordinary skill in the related art will be able to contemplate other implementations of the components of the invention.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

At least one embodiment of the invention may provide one or more beneficial effects, such as, for example, combining sort, join and other operations to reduce the amount of temporal information written and read from disks to reduce the time needed to write/read this information to/from disks.

It will be appreciated and should be understood that the exemplary embodiments of the invention described above can be implemented in a number of different fashions. Given the teachings of the invention provided herein, one of ordinary skill in the related art will be able to contemplate other implementations of the invention. Indeed, although illustrative embodiments of the present invention have been described herein with reference to the accompanying drawings, it is to be understood that the invention is not limited to those precise embodiments, and that various other changes and modifications may be made by one skilled in the art.

What is claimed is:

1. A method for accelerating an operation in a database management system, wherein the method comprises:
reading data pertaining to a database management system operation from a storage unit;
sending the database management system operation data to an accelerator unit; and
processing the database management system operation data via the accelerator unit, wherein processing the data via the accelerator unit comprises using a multithreaded execution unit and compression hardware to perform the database management system operation with reduced execution time.

2. The method of claim 1, wherein the database management system operation comprises a sort operation.

3. The method of claim 2, wherein:
an item of data, from a table, is read from the storage unit;
the data is sent to the accelerator unit through an interface;
the data is sorted via the multithreaded execution unit and sent to compression hardware for compression; and
the compressed data is sent back to the storage unit.

4. The method of claim 3, further comprising repeating the steps of sorting and compressing the data for the entirety of data from the table.

5. The method of claim 3, further comprising performing a merge process, wherein the merge process comprises:
reading one or more items of data from the storage unit;
sending the one or more items of data to the accelerator unit;
decompressing the one or more items of data on decompression hardware; and
performing a merge of the one or more items of data on the multithreaded execution unit.

6. The method of claim 1, wherein the database management system operation comprises a join operation.

7. The method of claim 6, wherein:
a first table, comprising one or more portions, is read from the storage unit;
each portion of the first table is sent to the accelerator unit;
each portion of the first table is hashed and compressed using compressor hardware; and
each compressed portion of the first table is sent back to the storage unit.

8. The method of claim 7, wherein:
a second table, comprising one or more portions, is read from the storage unit;
each portion of the second table is sent to the accelerator unit;
each portion of the second table is hashed and compressed using compressor hardware; and
each compressed portion of the second table is sent back to the storage unit.

9. The method of claim 8, further comprising:
reading each hashed, compressed and stored portion of the first and second tables from the storage unit;
sending each hashed, compressed and stored portion of the first and second tables to the accelerator unit;
decompressing each hashed, compressed and stored portion of the first and second tables; and
performing a join on the decompressed portions of the first and second tables.

10. The method of claim 8, wherein the second table is larger in size than the first table.

11. The method of claim 1, further comprising providing a system, wherein the system comprises one or more distinct software modules, each of the one or more distinct software modules being embodied on a tangible computer-readable recordable storage medium, and wherein the one or more distinct software modules comprise a storage module, an accelerator module, a multithreaded execution module, and a compression module executing on a hardware processor.

12. A computer program product comprising a tangible computer readable recordable storage medium including computer useable program code for accelerating an operation in a database management system, the computer program product including:
computer useable program code for reading data pertaining to a database management system operation from a storage unit;
computer useable program code for sending the database management system operation data to an accelerator unit; and
computer useable program code for processing the database management system operation data via the accelerator unit, wherein processing the data via the accelerator unit comprises using a multithreaded execution unit and compression hardware to perform the database management system operation with reduced execution time.

13. The computer program product of claim 12, wherein the database management system operation comprises a sort operation, and wherein the computer program product includes:
computer useable program code for reading an item of data, from a table, from the storage unit;
computer useable program code for sending the data to the accelerator unit through an interface;
computer useable program code for sorting the data via the multithreaded execution unit and sending the data to compression hardware for compression; and
computer useable program code for sending the compressed data back to the storage unit.

14. The computer program product of claim 13, further comprising computer useable program code for repeating the steps of sorting and compressing the data for the entirety of data from the table.

15. The computer program product of claim 13, further comprising computer useable program code for performing a merge process, wherein the computer useable program code for performing a merge process comprises:
computer useable program code for reading one or more items of data from the storage unit;
computer useable program code for sending the one or more items of data to the accelerator unit;
computer useable program code for decompressing the one or more items of data on decompression hardware; and
computer useable program code for performing a merge of the one or more items of data on the multithreaded execution unit.

16. The computer program product of claim 12, wherein the database management system operation comprises a join operation, and wherein the computer program product includes:
computer useable program code for reading a first table, comprising one or more portions, from the storage unit;
computer useable program code for sending each portion of the first table to the accelerator unit;
computer useable program code for hashing each portion of the first table and compressing each portion of the first table using compressor hardware; and
computer useable program code for sending each compressed portion of the first table back to the storage unit.

17. The computer program product of claim 16, further comprising:
computer useable program code for reading a second table, comprising one or more portions, from the storage unit;
computer useable program code for sending each portion of the second table to the accelerator unit;
computer useable program code for hashing each portion of the second table and compressing each portion of the second table using compressor hardware; and
computer useable program code for sending each compressed portion of the second table back to the storage unit.

18. The computer program product of claim 17, further comprising:
computer useable program code for reading each hashed, compressed and stored portion of the first and second tables from the storage unit;
computer useable program code for sending each hashed, compressed and stored portion of the first and second tables to the accelerator unit;
computer useable program code for decompressing each hashed, compressed and stored portion of the first and second tables; and
computer useable program code for performing a join on the decompressed portions of the first and second tables.

19. A system for accelerating an operation in a database management system, comprising:
a memory; and
at least one processor coupled to the memory and operative to:
read data pertaining to a database management system operation from a storage unit;
send the database management system operation data to an accelerator unit; and
process the database management system operation data via the accelerator unit, wherein processing the data via the accelerator unit comprises using a multithreaded execution unit and compression hardware to perform the database management system operation with reduced execution time.

20. The system of claim 19, wherein the database management system operation comprises a sort operation, and wherein the at least one processor coupled to the memory is operative to:
read an item of data, from a table, from the storage unit;
send the data to the accelerator unit through an interface;
sort the data via the multithreaded execution unit and send the data to compression hardware for compression; and
send the compressed data back to the storage unit.

21. The system of claim 20, wherein the at least one processor coupled to the memory is further operative to perform a merge process, and wherein the at least one processor coupled to the memory operative to perform a merge process is further operative to:
read one or more items of data from the storage unit;
send the one or more items of data to the accelerator unit;
decompress the one or more items of data on decompression hardware; and
perform a merge of the one or more items of data on the multithreaded execution unit.

22. The system of claim 19, wherein the database management system operation comprises a join operation, and wherein the at least one processor coupled to the memory is operative to:
read a first table, comprising one or more portions, from the storage unit;
send each portion of the first table to the accelerator unit;
hash each portion of the first table and compress each portion of the first table using compressor hardware; and
send each compressed portion of the first table back to the storage unit.

23. The system of claim 22, wherein the at least one processor coupled to the memory is further operative to:
read a second table, comprising one or more portions, from the storage unit;
send each portion of the second table to the accelerator unit;
hash each portion of the second table and compress each portion of the second table using compressor hardware; and
send each compressed portion of the second table back to the storage unit.

24. The system of claim 23, wherein the at least one processor coupled to the memory is further operative to:
read each hashed, compressed and stored portion of the first and second tables from the storage unit;
send each hashed, compressed and stored portion of the first and second tables to the accelerator unit;
decompress each hashed, compressed and stored portion of the first and second tables; and
perform a join on the decompressed portions of the first and second tables.

25. An apparatus for accelerating an operation in a database management system, the apparatus comprising:
means for reading data pertaining to a database management system operation from a storage unit;
means for sending the database management system operation data to an accelerator unit; and
means for processing the database management system operation data via the accelerator unit, wherein processing the data via the accelerator unit comprises using a multithreaded execution unit and compression hardware to perform the database management system operation with reduced execution time.
